(19) United States
(12) Patent Application Publication
(10) Pub. No.: US 2016/0340552 A1
(43) Pub. Date: Nov. 24, 2016

(54) MASTIC ASPHALT COMPOSITIONS WITH COALESCENTS

(71) Applicants: InVia Pavement Technologies, LLC, Tulsa, OK (US); Eastman Chemical Company, Kingsport, TN (US)

(72) Inventors: Timothy M. O'Connell, Tulsa, OK (US); Joseph Lorenc, Philadelphia, PA (US); Jerry M. Mitchell, Blountville, TN (US); Ronnie J. Price, Sapulpa, OK (US)

(21) Appl. No.: 15/158,118

(22) Filed: May 18, 2016

Related U.S. Application Data
(60) Provisional application No. 62/163,161, filed on May 18, 2015.

(51) Int. Cl. C09D 195/00; C09D 7/12; B05D 1/02; C04B 26/26

(52) U.S. Cl. CPC C09D 195/005; C04B 26/26; C09D 7/125; B05D 1/02; C04B 2111/00577

(57) ABSTRACT

The present description relates to an asphalt coating composition, and method of application, for coating asphalt paving surfaces. In particular, the asphalt compositions comprises bitumen, a coalescent and a latex polymer, wherein the asphalt has a good drying rate, especially in cool, high humidity, or shaded conditions.

### CROSS-REFERENCE TO RELATED APPLICATIONS

This application claims the benefit of U.S. Provisional Patent Application 62/163,161, filed: May 18, 2015, titled: “Mastic Asphalt Compositions with Coalescents”, which is incorporated herein by reference.

### BACKGROUND

1. Field of the Art

The present disclosure relates to a bituminous mix usable in particular in the paving industry, which comprises a bitumen emulsion in aqueous phase mixed with aggregates, and further including a coalescent, and a latex polymer.

2. Description of Related Art

Mastic asphalt or asphalt sealer coating materials are asphalt or bitumen-based materials that are used for paving, roofing and flooring applications. However, generally extremely high temperatures are required in order to convert mastic asphalt into a thick, liquid substance that can be poured or spread over a surface. Mastic asphalt is similar to traditional asphalt concrete (i.e., asphalt or bitumen with aggregate) in that it forms a very dense solid-surface after drying.

Asphalt concrete is fairly permeable under most conditions, allowing some moisture to seep through. However, mastic versions are virtually waterproof, and can be used in applications where moisture-resistance is a primary concern. The impervious quality of mastic asphalt can be attributed to its relatively high concentration of bitumen. Bitumen is a by-product of petroleum refinement, and is used as a binding agent in asphalt-based products. The bitumen content in mastic mixtures is typically double that found in concrete asphalt, which helps to bind the particles more closely together to keep water out.

Mastic asphalt can be laid on most types of rigid substructures such as concrete, timber and metal decking. Furthermore, thermal insulation materials can be easily laid as part of a mastic asphalt roofing specification to give any required U-value. Mastic asphalt has a long and successful history as a waterproofing medium for flat roofs, basements and foundations as well as a surfacing material for floors, pavements, car parks and bridge decks. Mastic asphalt roofing can be applied to form a continuous waterproof covering over flat, sloped or curved surfaces and can be worked around pipes, roof lights and other projections.

As mentioned above, mastic asphalts must generally be heated to high temperatures, e.g., 210° C. or higher, in order to liquefy the bitumen such that it is suitable for spreading on a pavement surface. Some technologies allow asphalt/bitumen to be mixed at much lower temperatures, such as, for example, mixing with petroleum solvents to form “cutbacks” with reduced melting point, or mixtures with water to turn the asphalt/bitumen into an emulsion. Asphalt emulsions may contain up to 70% asphalt/bitumen and typically include additives, emulsifiers, such as cationic or anionic emulsifiers.

However, current mastic asphalt emulsion technologies suffer from a common problem that limits their use, which is that although the material forms a spreadable liquid at lower temperatures, the material dries too slowly or incompletely in cool, high humidity or shaded pavement conditions. In addition, asphalt emulsions are also typically unstable, making them unsuitable for storage and/or requiring on-site heating and mixing. Consequently, a need exists for an improved mastic asphalt or asphalt seal coating composition, which can be applied using conventional equipment, that is highly durable, can be pre-mixed, stored, and transported for later use, and is able to be applied in cool, high humidity or shaded pavement conditions while providing good drying rates.

### SUMMARY

The present description relates to mastic asphalt compositions and methods of using and applying the same. It was surprisingly and unexpectedly discovered that certain combinations of additives, e.g., a coalescent and a polymer, such as a latex polymer, could be added to mastic asphalt formulations in order to reduce its minimum film formation temperature while obtaining good drying rates, rendering the mastic asphalt composition suitable for application in cool, high humidity, or shaded conditions.

The disclosure provides a mastic asphalt composition comprising asphalt or bitumen emulsion, aggregate, a polymer, e.g., a latex polymer, and a coalescent. In certain embodiments, the mastic asphalt compositions as described herein are liquid at ambient temperatures or temperatures below 100° C. In certain embodiments, the compositions as described herein are configured for spray coating or spray sealing. The compositions can be used to coat, e.g., spray coat or spray seal, any type of surface, for example, parking, driveway, walking, or roofing surfaces.

The mastic asphalt composition can also further comprise at least one of water, a particulate re-enforcing material, an additive or a combination of thereof. Additionally or in the alternative, the additive can comprise at least one of a surfactant, emulsifier, rheology modifier, stabilizer, a filler, co-polymer or combination thereof. In certain embodiments, each of water, a particulate re-enforcing material, and/or an additive can independently be present in an amount of from 0% wt to about 25% wt based on the total weight of the mastic asphalt composition.

In certain embodiments, the emulsifier is selected from the group consisting of anionic, cationic, and non-ionic. In still additional embodiments, the mastic asphalt composition comprises a synthetic aggregate.

In any of the embodiments described herein, the particulate re-enforcing material is clay.

In any of the embodiments described herein, the polymer is a latex polymer or latex co-polymer.

In any of the embodiments described herein, the coalescent or coalescing agent can be an ester, ester alcohol, glycol ether, or glycol ether ester. The ester alcohol can be a substituted or unsubstituted C1-C20 ester alcohol compound. In certain additional embodiments, the coalescent comprises at least one or an ester, an ester alcohol, a substituted or unsubstituted C1-C20 ester alcohol compound, 2,2,4-trimethyl, 1,3-pentanediol di-isobutyrate (TXIB), 2,2,4-trimethyl-1,3-pentanediol monoisobutyrate (i.e., compound of formula (I)), derivatives, analogs thereof or combinations thereof.

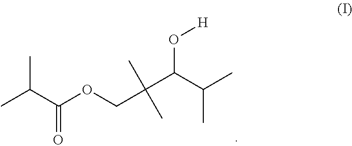

In another aspect, the disclosure provides a structure, e.g., a pavement or roofing structure, comprising one or more layers of the mastic asphalt as described herein. In certain embodiments, the asphalt compositions as described herein are applied at from about 1 lb/sq. yd to about 20 lb/sq. yd. In certain embodiments, the asphalt compositions as described herein are applied at from about 5 lb/sq. yd. to about 15 lb/sq. yd. In another aspect, the disclosure provides methods of using the compositions as described herein to coat or seal a surface, e.g., parking, driving, walking or roofing surfaces. In certain embodiments, the method comprises the steps of, providing a mastic asphalt composition as described herein and applying the mastic asphalt at a sufficient amount to coat or seal (partially or completely) a surface, wherein the asphalt mastic dries faster in cool, high humidity or shaded pavement conditions, for example, conditions such as 60 F air temperature, 75% relative humidity, no direct sunlight and pavement temperatures less than 100° F. relative to an asphalt mastic lacking a coalescent and a polymer.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages, objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

FIG. 1 is a diagram depicting the progression of film formation using a coalescing aid.

### DETAILED DESCRIPTION

The following is a detailed description provided to aid those skilled in the art in practicing the present invention. Those of ordinary skill in the art may make modifications and variations in the embodiments described herein without departing from the spirit or scope of the present disclosure. All publications, patent applications, patents, figures and other references mentioned herein are expressly incorporated by reference in their entirety. In particular, US 2014/0373750 A1, is incorporated herein by reference in its entirety.

Presently described are mastic asphalt compositions and methods of using and applying the same that relate to the surprising and unexpected discovered that certain combinations of additives, e.g., a coalescent and a polymer, such as a latex polymer, could be added to mastic asphalt formulations in order to improve or enhance the drying rate, especially in cool, high humidity, or shaded conditions. The mastic asphalt as described herein can be used in numerous applications, including pavement and roofing applications, as well as other water based or emulsified asphalt applications, including, chip seals, slurry seal, micro surfacing, and various cold mix applications.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. Unless otherwise defined, all technical and scientific terms used herein have the same meaning as commonly understood by one of ordinary skill in the art to which this invention belongs. The terminology used in the description is for describing particular embodiments only and is not intended to be limiting of the invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “compound”, as used herein, unless otherwise indicated, refers to any specific chemical compound disclosed herein and includes tautomers, regioisomers, geometric isomers, and where applicable, stereoisomers, including optical isomers (enantiomers) and other steroisomers (diastereomers) thereof, as well as salts and derivatives thereof where applicable, in context. Within its use in context, the term compound generally refers to a single compound, but also may include other compounds such as stereoisomers, regioisomers and/or optical isomers (including racemic mixtures) as well as specific enantiomers or enantiomerically enriched mixtures of disclosed compounds. It is noted that in describing the present compounds, numerous substituents and variables associated with same, among others, are described. It is understood by those of ordinary skill that molecules which are described herein are stable compounds as generally described hereunder.

A coalescent is a compound that acts as a temporary plasticizer to reduce the Tg of a latex polymer below that of the drying temperature and has the capability of fusing the latex particles that come into contact with each other to form a coherent mastic asphalt film. The coalescent is effective only if it can reduce the Tg of the latex polymers during the film formation process to a temperature lower than the temperature at which the drying occurs. The coalescent, while having plasticizing properties that can facilitate elastic deformation of latex particles and increase the free volume of the latex, is distinguished from a plasticizer in that a coalescent will also evaporate sufficiently to allow the Tg of the film to recover to or above the drying temperature at which the mastic asphalt composition is applied. With a plasticizer, a sufficient amount of plasticizer remains in the film after drying such that the Tg of the film is lower than the drying temperature.

The mastic asphalt composition has a minimum film formation temperature (“MFFT”) that is less than the MFFT of the mastic asphalt composition without the coalescing aid. The minimum forming temperature of the mastic asphalt composition is the lowest temperature at which coherent film formation occurs. Below the MFFT, the casting or coating is mechanically unstable, brittle and/or will crack, flake or even form a powder.

“Bitumen” can refer to a mixture of viscous organic liquids or semi-solids from crude oil that is black, sticky, soluble in carbon disulfide, and composed primarily of condensed aromatic hydrocarbons. Alternatively, bitumen refers to a mixture of maltenes and asphaltenes. Bitumen may be any conventional type of bitumen known to the skilled person. The bitumen may be naturally occurring. It may be crude bitumen, or it may be refined bitumen obtained as the bottom residue from vacuum distillation of crude oil, thermal cracking, hydrocracking or obtained from reclaimed asphalt pavement.

“Asphalt” is sometimes used interchangeably with bitumen to describe the binder. Generally, the term “asphalt concrete” is used to describe the binder plus the aggregate. In this description, “asphalt mastic” refers to the composite material comprising an asphalt or bituminous binder and aggregate, which is generally used for paving or roofing applications. Unless the context clearly indicates otherwise, the term “mastic asphalt” is used herein in a general and collective sense to refer to all mastic asphalts described herein, sprayable or otherwise. Asphalt is commonly qualified for paving applications. Examples of asphalt grades used in paving applications include stone mastic asphalt, soft asphalt, hot rolled asphalt, dense-graded asphalt, gap-graded asphalt, porous asphalt, mastic asphalt, and other asphalt types. Typically, the total amount of bituminous binder in asphalt is from 1 to 10% wt based on the total weight of the asphalt composition.

Mastic Asphalt Compositions

In one aspect, the disclosure provides a mastic asphalt composition comprising asphalt or bitumen emulsion, aggregate, a polymer, e.g., a latex polymer, and an effective amount of a coalescent, wherein the composition demonstrates an improved or enhanced feature as described herein, e.g., improved drying rate, especially in cool, high humidity, or shaded conditions, for example, as compared to the mastic asphalt in the absence of the coalescent.

In any of the aspects or embodiments described herein, the mastic asphalt compositions can comprise any suitable bitumen or asphalt material that is generally known in the art or that becomes known. In certain embodiments, the mastic asphalt composition comprises from about 1% wt to about 50% wt of asphalt or bitumen emulsion based on the total weight of the mastic asphalt composition.

Those of skill in the art will recognize that certain types of bitumen or asphalt are particularly useful for mastic asphalt or asphalt sealer applications, which are expressly contemplated herein. For example, in certain embodiments, the compositions comprise asphalt, such as, SHRP Performance Asphalt Grades PG 64-22, PG 58-28, asphalts of penetration grade 20-30, 40-50, 60-70, 85-100, 120-150 (but not limited to the listed), emulsions prepared with the referenced asphalts of CSS-1h, CSS-1, SS-1, SS-1h and others.

In certain additional embodiments, the mastic asphalt compositions as described herein also comprise an aggregate material. Aggregate” (or “construction aggregate”) is particulate mineral material suitable for use in asphalt. It generally comprises sand, gravel, crushed stone, and slag. Any conventional type of aggregate suitable for use in mastic asphalt can be used. Examples of suitable aggregates include granite, limestone, gravel, and mixtures thereof. The aggregate portion of the composition can preferably, in one example, comprise approximately from about 0% wt to about 90% wt of the total weight of the mastic asphalt composition.

Aggregate used in paving materials and road construction, road rehabilitation, road repair, and road maintenance are derived from natural and synthetic sources. As in any construction process, aggregate are selected for asphalt paving applications based on a number of criteria, including physical properties, compatibility with the bitumen to be used in the construction process, availability, and ability to provide a finished pavement that meets the performance specifications of the pavement layer for the traffic projected over the design life of the project. Among the aggregate properties that is key to successful road construction is gradation, which refers to the percent of aggregate particles of a given size. For most load-bearing asphalt pavements, three gradations are common: dense-graded, gap-graded, and open-graded. Dense-graded aggregate exhibit the greatest mineral surface area (per unit of aggregate). Open-graded aggregate largely consist of a single, large-sized (e.g., around 0.375 to 1.0 inch) stone with very low levels (typically less than about two percent of the total aggregate) of fines (material less than 0.25 inch) or filler (mineral material less than 0.075 mm). Gap graded aggregate fall between dense-graded and open-graded classes. Reclaimed asphalt pavement (RAP) material generally reflects the gradation of the pavement from which the reclaimed material was obtained. If the original pavement was a dense-graded mix, the RAP will also be dense graded, although the filler content is generally observed to be lower than the design limits of the origin aggregate specifications.

In certain embodiments, the aggregate material included in the mastic asphalt as described herein has an AASHTO T-19 loose bulk weight of from 45 to 90 pounds per cubic foot. In certain additional embodiments, the aggregate material included in the mastic asphalt as described herein has an AASHTO T-19 packed bulk unit weight which is not more than 98 pounds per cubic foot. See, e.g., US 2014/0373750 A1, which is incorporated herein by reference.

Any aggregate which is traditionally employed in the production of bituminous paving or roofing compositions is suitable for use in the present disclosure, including dense-graded aggregate, gap-graded aggregate, open-graded aggregate, reclaimed asphalt pavement, and mixtures thereof. Aggregate which is not fully dried can be employed in the present disclosure. The aggregate material portion of the composition may preferably comprise, in one example, a combination of crushed stone and mineral filler material.

The mastic asphalt compositions as described herein are advantageous because they are water-based asphalt emulsions that require significantly less heat to form a fluid or spreadable mastic asphalt, they are stable, which allows for pre-blending and longer term storage, and are able to dry at lower temperatures and higher humidity than currently available compositions.

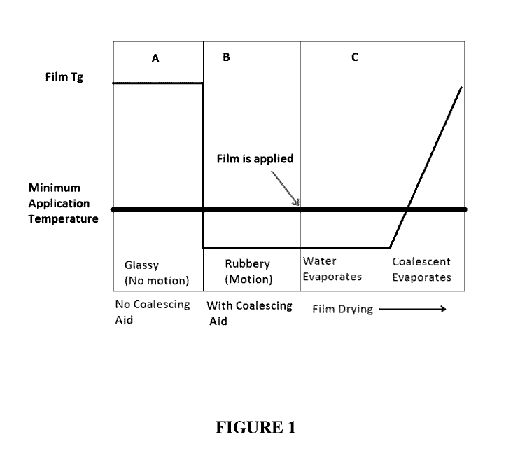

The mastic asphalt composition of the invention contains a coalescent. As noted above, the coalescent is a compound that acts as a temporary plasticizer to reduce the Tg of a latex polymer below that of the drying temperature, has the capability of fusing the latex particles that come into contact with each other to form a coherent mastic asphalt film, and also will also evaporate sufficiently to allow the Tg of the film to recover to or above the termperature at which the mastic asphalt composition is applied. The behavior of a coalescent can be further illustrated in a non-limiting manner by reference to FIG. 1. Without a coalescent aid, the Tg of the latex polymer in the mastic asphalt composition remains above the drying temperature. Once the coalescent is admixed into a mastic asphalt composition, it lowers Tg of the mastic asphalt composition to a temperature below that of the drying temperature. Over time, the particles will deform, consolidate and compact and eventually coalesce to form a dried coherent film. During the initial stages of drying, water is evaporating while a substantial amount of the coalescent remains in the mastic asphalt composition to cause the polymer particles to compact and coalese. Toward the tail end of the dry time and during coalescence and after a substantial amount of the water has evaporated, the coalescent will evaporate, and as it does, the Tg of the mastic asphalt composition rises. Sufficient amount of the coalescent evaporate to allow the Tg of the mastic asphalt composition to rise above the drying temperature, and desirably at or near (e.g. within 20%) of the Tg of the original latex polymer.

If desired, the coalescent can evaporate out of the mastic asphalt composition at a rate sufficient to raise the Tg of the mastic asphalt composition above the drying temperature within 12 hours, or within 10 hours, or within 8 hours, or within 6 hours, or within 4 hours, or within 2 hours of applying the mastic asphalt composition to a substrate. Under the MFFT test conditions described above, the coalescent used can be one that evaporates sufficiently to raise the Tg of the mastic asphalt composition at or above the drying temperature within 90 minutes, or within 60 minutes, or within 40 minutes, or within 20 minutes of applying it to the draw down bar.

The coalescent will drop the MFFT of the mastic asphalt composition. The MFFT of the mastic asphalt composition of the invention is lower than the Tg of the same mastic asphalt composition without coalescent. The MFFT of the mastic asphalt composition can be 80° F., 70° F., 60° F. or less, or 58° or less, or 56° or less, or 55° or less, or 53° or less, or 52° or less, or 50° or less, or 48° or less, or 46° or less, or 45° or less, or 43° or less, or 42° or less, or 41° or less, or 40° or less, including all values in between. Additionally or in the alternative, the MFFT of the mastic asphalt composition is 32° F. or more, or 35° F. or more, or 39° F. or more. Suitable ranges include 32-60, or 32-58, or 32-56, or 32-55, or 32-53, or 32-52, or 32-50, or 32-48, or 32-46, or 32-45, or 32-43, or 32-42, or 32-41, or 32-40, or 35-60, or 35-58, or 35-56, or 35-55, or 35-53, or 35-52, or 35-50, or 35-48, or 35-46, or 35-45, or 35-43, or 35-42, or 35-41, or 35-40, or39-60, or 39-58, or 39-56, or 39-55, or 39-53, or 39-52, or 39-50, or 39-48, or 39-46, or 39-45, or 39-43, or 39-42, or 39-41, or 39-40, or 42-60, or 42-58, or 42-56, or 42-55, or 42-53, or 42-52, or 42-50, or 42-48, or 42-46, or 42-45, or 42-43, or 45-42, or 45-41, or 45-40, or45-60, or 45-58, or 45-56, or 45-55, or 45-53, or 45-52, or 45-50, or 45-48, or 45-46, or 47-60, or 47-58, or 47-56, or 47-55, or 47-53, or 47-52, or 47-50, or 47-48, or 49-60, or 49-58, or 49-56, or 49-55, or 49-53, or 49-52, or 49-50. These MFFT values are useful when applying the mastic asphalt compositions in shady or cloudy conditions and/or on cooler days. If desired, the amount of coalescent can be adjusted to attain the desired MMFT that is effective to meet the conditions during application of the mastic asphalt composition, whether or a warm, cool, shady, cloudy, or humid condition.

For purposes of measuring the MFFT of an asphalt composition, the following test method is employed. The MFFT of the mastic asphalt composition can be determined by the resist method using an MFFT machine using the ASTM 2354 standards. The typical visual method for determining the MFFT (the point where the film is no longer has haze) is not suitable for evaluating the mastic asphalt composition of the invention because its black color masks the haze and fine cracks. With the resist method, the coating cast using a 6 mil gap draw down bar is scraped off the surface of the machine with a spatula. The temperature at which the coating stops flaking off, starts to roll up and adhere to itself, and becomes more resistant to scraping is determined to be the point of coalescence by this method.

The amount of coalescent used can be at least 0.01 part per hundred (phr), or 0.1 phr, or at least 0.25 phr, or at least 0.5 phr, or at least 0.75 phr, or at least 1 phr, or at least 1.25 phr, or at least 1.5 phr, or at least 1.75 phr, or, at least 2 phr, or at least 2.25 phr, or at least 2.5 phr, or at least 2.75 phr, or at least 3 phr, or at least 3.25 phr, or at least 3.5 phr, or at least 3.75 phr, or, at least 4 phr, or at least 4.25 phr, or at least 4.5 phr, or at least 4.75 phr, or at least 5 phr, and up to 10 phr, or up to 9 phr, or up to 8 phr, or up to 7 phr, or up to 6 phr, or up to 5 phr, or up to 4.5 phr, or up to 4.25 phr, or up to 4 phr, or up to 3.75 phr, or up to 3.5 phr, or up to 3.25 phr, or up to 3 phr, or up to 2.75 phr, or up to 2.5 phr, or up to 2.25 phr, or up to 2 phr, or up to 1.75 phr, or up to 1.5 phr, or up to 1.25 phr, in each case based on addition to 100 part of the mastic asphalt composition solids (non-volatiles). Examples of suitable ranges include 0.01-10, or 0.01-9, or 0.01-8, or 0.01-7, or 0.01-6, or 0.01-5, or 0.01-4.5, or 0.01-4.25, or 0.01-4, or 0.01-3.75 or 0.01-3.5, or 0.01-3.25, or 0.01-3, or 0.01-2.75, or 0.01-2.5, or 0.01-2.25, or 0.01-2, or 0.01-1.75, or 0.01-1.5, or 0.01-1.25, or 0.1-10, or 0.1-9, or 0.1-8, or 0.1-7, or 0.1-6, or 0.1-5, or 0.1-4.5, or 0.1-4.25, or 0.1-4, or 0.1-3.75 or 0.1-3.5, or 0.1-3.25, or 0.1-3, or 0.1-2.75, or 0.1-2.5, or 0.1-2.25, or 0.1-2, or 0.1-1.75, or 0.1-1.5, or 0.1-1.25, or 0.25-10, or 0.25-9, or 0.25-8, or 0.25-7, or 0.25-6, or 0.25-5, or 0.25-4.5, or 0.25-4.25, or 0.25-4, or 0.25-3.75 or 0.25-3.5, or 0.25-3.25, or 0.25-3, or 0.25-2.75, or 0.25-2.5, or 0.25-2.25, or 0.25-2, or 0.25-1.75, or 0.25-1.5, or 0.25-1.25, or 0.5-10, or 0.5-9, or 0.5-8, or 0.5-7, or 0.5-6, or 0.5-5, or 0.5-4.5, or 0.5-4.25, or 0.5-4, or 0.5-3.75 or 0.5-3.5, or 0.5-3.25, or 0.5-3, or 0.5-2.75, or 0.5-2.5, or 0.5-2.25, or 0.5-2, or 0.5-1.75, or 0.5-1.5, or 0.5-1.25, or 0.75-10, or 0.75-9, or 0.75-8, or 0.75-7, or 0.75-6, or 0.75-5, or 0.75-4.5, or 0.75-4.25, or 0.75-4, or 0.75-3.75 or 0.75-3.5, or 0.75-3.25, or 0.75-3, or 0.75-2.75, or 0.75-2.5, or 0.75-2.25, or 0.75-2, or 0.75-1.75, or 0.75-1.5, or 0.75-1.25, or 1-10, or 1-9, or 1-8, or 1-7, or 1-6, or 1-5, or 1-4.5, or 1-4.25, or 1-4, or 1-3.75 or 1-3.5, or 1-3.25, or 1-3, or 1-2.75, or 1-2.5, or 1-2.25, or 1-2, or 1-1.75, or 1-1.5, or 1-1.25, or 1.25-10, or 1.25-9, or 1.25-8, or 1.25-7, or 1.25-6, or 1.25-5, or 1.25-4.5, or 1.25-4.25, or 1.25-4, or 1.25-3.75 or 1.25-3.5, or 1.25-3.25, or 1.25-3, or 1.25-2.75, or 1.25-2.5, or 1.25-2.25, or 1.25-2, or 1.25-1.75, or 1.25-1.5, or 1.5-10, or 1.5-9, or 1.5-8, or 1.5-7, or 1.5-6, or 1.5-5, or 1.5-4.5, or 1.5-4.25, or 1.5-4, or 1.5-3.75 or 1.5-3.5, or 1.5-3.25, or 1.5-3, or 1.5-2.75, or 1.5-2.5, or 1.5-2.25, or 1.5-2, or 1.5-1.75, or 1.75-10, or 1.75-9, or 1.75-8, or 1.75-7, or 1.75-6, or 1.75-5, or 1.75-4.5, or 1.75-4.25, or 1.75-4, or 1.75-3.75 or 1.75-3.5, or 1.75-3.25, or 1.75-3, or 1.75-2.75, or 1.75-2.5, or 1.75-2.25, or 1.75-2, or 2-10, or 2-9, or 2-8, or 2-7, or 2-6, or 2-5, or 2-4.5, or 2-4.25, or 2-4, or 2-3.75 or 2-3.5, or 2-3.25, or 2-3, or 2-2.75, or 2-2.5, or 2-2.25, or 2.25-10, or 2.25-9, or 2.25-8, or 2.25-7, or 2.25-6, or 2.25-5, or 2.25-4.5, or 2.25-4.25, or 2.25-4, or 2.25-3.75 or 2.25-3.5, or 2.25-3.25, or 2.25-3, or 2.25-2.75, or 2.25-2.5, or 2.5-10, or 2.5-9, or 2.5-8, or 2.5-7, or 2.5-6, or 2.5-5, or 2.5-4.5, or 2.5-4.25, or 2.5-4, or 2.5-3.75 or 2.5-3.5, or 2.5-3.25, or 2.5-3, or 2.5-2.75, or 2.75-10, or 2.75-9, or 2.75-8, or 2.75-7, or 2.75-6, or 2.75-5, or 2.75-4.5, or 2.75-4.25, or 2.75-4, or 2.75-3.75 or 2.75-3.5, or 2.75-3.25, or 2.75-3, or 3-10, or 3-9, or 3-8, or 3-7, or 3-6, or 3-5, or 3-4.5, or 3-4.25, or 3-4, or 3-3.75 or 3-3.5, or 3-3.25, or 3.25-10, or 3.25-9, or 3.25-8, or 3.25-7, or 3.25-6, or 3.25-5, or 3.25-4.5, or 3.25-4.25, or 3.25-4, or 3.25-3.75 or 3.25-3.5, or 3.5-10, or 3.5-9, or 3.5-8, or 3.5-7, or 3.5-6, or 3.5-5, or 3.5-4.5, or 3.5-4.25, or 3.5-4, or 3.5-3.75 or 3.75-10, or 3.75-9, or 3.75-8, or 3.75-7, or 3.75-6, or 3.75-5, or 3.75-4.5, or 3.75-4.25, or 3.75-4, or 4-10, or 4-9, or 4-8, or 4-7, or 4-6, or 4-5, or 4-4.5, or 4-4.25, or 4.25-10, or 4.25-9, or 4.25-8, or 4.25-7, or 4.25-6, or 4.25-5, or 4.25-4.5, or 4.5-10, or 4.5-9, or 4.5-8, or 4.5-7, or 4.5-6, or 4.5-5, or 4.75-10, or 4.75-9, or 4.75-8, or 4.75-7, or 4.75-6, or 4.75-5, or 5-10, or 5-9, or 5-8, or 5-7, or 5-6, in each case phr.

The amount of coalescent can be quite effective at low amounts, such as 0.01-4, or 0.01-3.75 or 0.01-3.5, or 0.01-3.25, or 0.01-3, or 0.01-2.75, or 0.01-2.5, or 0.01-2.25, or 0.01-2, or 0.01-1.75, or 0.01-1.5, or 0.01-1.25, or 0.1-4, or 0.1-3.75 or 0.1-3.5, or 0.1-3.25, or 0.1-3, or 0.1-2.75, or 0.1-2.5, or 0.1-2.25, or 0.1-2, or 0.1-1.75, or 0.1-1.5, or 0.1-1.25, or 0.25-4, or 0.25-3.75 or 0.25-3.5, or 0.25-3.25, or 0.25-3, or 0.25-2.75, or 0.25-2.5, or 0.25-2.25, or 0.25-2, or 0.25-1.75, or 0.25-1.5, or 0.25-1.25, or 0.5-4, or 0.5-3.75 or 0.5-3.5, or 0.5-3.25, or 0.5-3, or 0.5-2.75, or 0.5-2.5, or 0.5-2.25, or 0.5-2, or 0.5-1.75, or 0.5-1.5, or 0.5-1.25, or 0.75-4, or 0.75-3.75 or 0.75-3.5, or 0.75-3.25, or 0.75-3, or 0.75-2.75, or 0.75-2.5, or 0.75-2.25, or 0.75-2, or 0.75-1.75, or 0.75-1.5, or 0.75-1.25, or 1-4, or 1-3.75 or 1-3.5, or 1-3.25, or 1-3, or 1-2.75, or 1-2.5, or 1-2.25, or 1-2, or 1-1.75, or 1-1.5, or 1.25-4, or 1.25-3.75 or 1.25-3.5, or 1.25-3.25, or 1.25-3, or 1.25-2.75, or 1.25-2.5, or 1.25-2.25, or 1.25-2, or 1.25-1.75, or 1.25-1.5, or 1.5-4, or 1.5-3.75 or 1.5-3.5, or 1.5-3.25, or 1.5-3, or 1.5-2.75, or 1.5-2.5, or 1.5-2.25, or 1.5-2, or 1.5-1.75, or 1.75-4, or 1.75-3.75 or 1.75-3.5, or 1.75-3.25, or 1.75-3, or 1.75-2.75, or 1.75-2.5, or 1.75-2.25, or 1.75-2, or 2-4, or 2-3.75 or 2-3.5, or 2-3.25, or 2-3, or 2-2.75, or 2-2.5, or 2-2.25, or 2.25-4, or 2.25-3.75 or 2.25-3.5, or 2.25-3.25, or 2.25-3, or 2.25-2.75, or 2.25-2.5, or 2.5-4, or 2.5-3.75 or 2.5-3.5, or 2.5-3.25, or 2.5-3, or 2.5-2.75, or 2.75-4, or 2.75-3.75 or 2.75-3.5, or 2.75-3.25, or 2.75-3, or 3-4, or 3-3.75 or 3-3.5, or 3-3.25, or 3.25-4, or 3.25-3.75 or 3.25-3.5, or 3.5-4, or 3.5-3.75 or 3.75-4, in each case in phr.

For applications under many conditions, such as where the application temperature is below 62° F., the amount of coalescent used can be even lower, such as 3 or less, or 2.75 or less, or 2.5 or less, or 2.25 or less, or 2 or less, or 1.75 or less, or 1.5 or less, of 1.25 or less, and in each case at least 0.01, in each case as phr.\

If desired, the amount of coalescent used can be effective to dry the mastic asphalt composition in under 120 minutes, or under 100 minutes, or under 90 minutes, or under 80 minutes, or under 70 minutes, or under 60 minutes, or under 50 minutes, or under 40 minutes, or under 35 minutes, or under 30 minutes, when measured under the following conditions: cast using a 6 mil gap draw down bar, heated to 59° F., under a flow of air at 4 liter/min and a pressure of 60 psi, time zero when cast, and determined as dried upon a color change from jet black to charcoal gray.

The type and amount coalescent used is desirably effective to shorten the drying time of a mastic asphalt composition relative to the same mastic asphalt composition without the coalescent. Desirably, the coalescent can reduce the dry time by at least 20%, or at least 25%, or at least 30%, or at least 35%, or at least 40%, or at least 45%, or at least 50%, when measured at 59° F. The dry time of the mastic asphalt composition without the coalescent is measured at 59° F. and recorded as DTI, the dry time of the mastic asphalt composition with the coalescing aid is measured at 59° F. and recorded as DT2, and the percent reduction in dry time % RDT is equal to (DT1−DT2)/DT1×100.

Although water has a faster rate of evaporation than a given coalescent, the dry time of a aqueous mastic asphalt composition containing such a coalescent can be faster than an aqueous mastic asphalt composition without the coalescent. One would expect an aqueous asphalt composition without the coalescent to dry faster. However, the mastic asphalt composition of the invention containing coalescents having a lower rate of evaporation than water can nevertheless dry faster than same mastic asphalt composition without the coalescent. It is believed that the phenomena at work contributing to faster drying time is not due solely to the rate of evaporation of volatiles, but also to the effect that a coalescent have on the mastic asphalt composition. Without being bound to a theory, it is believed that the action of the coalescent in lowering the Tg of the latex particles increases the available free volume of latex, perhaps by disentagling the thermoplastic long polymer chains, decreasing the Van der Waal's forces between the chains and increasing the flexibility between the chains, which can be quantified by a lower Tg. This flexibility between chains can enhance the mass transfer of water molecules to the surface at a faster rate than would be experienced without the coalescing aid, thereby exposing a greater amount of water closer to the surface of the mastic asphalt composition to evaporation. If water immiscible coalescent aids are employed, it is believed that the mass transfer of water to the surface is enhanced as the latex particles consolidate. Thus, the rate of evaporation of a compound is not the sole factor contributing to the rate of film drying.

The coalescent can be, and desirably is, a slow evaporating solvent, which is counterintuitive since one would expect that a slow evaporating solvent would significantly impair drying times. The coalescent desirably has a rate of evaporation that is lower than that of water, or 0.25 or less, or 0.20 or less, or 0.17 or less, or 0.15 or less, or 0.13 or less, or 0.10 or less, or 0.08 or less, or 0.05 or less, or 0.03 or less, or 0.02 or less, or 0.01 or less, or less than 0.01, or 0.008 or less, or 0.006 or less, or 0.005 or less, or 0.004 or less, in each case relative to n-butyl acetate as the standard having a value of 1.0 as determined by the “Method of Evaporation Rates of Volatile Liquids by the Shell Thin-Film Evaporometer—ASTM D3539.

As mentioned above, the coalescent will evaporate from the film to increase the Tg of the mastic asphalt composition at or above the temperature at which the mastic asphalt composition is applied. Desirably, the coalescent can also have a rate of evaporation that is at least higher than that of 2,2,4-trimethyl, 1,3-pentanediol di-isobutyrate (TXIB), having a ER of about 0.0004 using n-butyl acetate ER=1 as a reference.

The type of coalescent employed is not particularly limited, provided that it acts as a coalescent. Non-limiting types of coalescents include esters, ester alcohols, glycol ethers, and glycol ether esters.

Examples include ethylene glycol ethyl ether, ethylene glycol propyl ether (Eastman EP and Propyl Cellosolve), ethylene glycol butyl ether (Eastman EB and Butyl Cellosolve), ethylene glycol 2-ethylhexyl ether (Eastman EEH), diethylene glycol methyl ether (Eastman DM and Methyl Carbitol), diethylene glycol ethyl ether (Eastman DE and Ethyl Carbitol), diethylene glycol propyl ether (Eastman DP and Propyl Carbitol), diethylene glycol butyl ether (Eastman DB and Butyl Carbitol), propylene glycol methyl ether (Eastman PM and Dowanol PM), ethylene glycol butyl ether acetate (Eastman EB Acetate and Butyl Cellosolve Acetate), diethylene glycol ethyl ether acetate (Eastman DE Acetate and Butyl Carbitol Acetate), propylene glycol methyl ether acetate (Eastman PM Acetate and Dowanol PMA), propylene glycol n-butyl ether (Dowanol PnB), dipropylene glycol n-butyl ether (Dowanol DPnB), tripropylene glycol n-butyl ether (Dowanol TPnB), propylene glycol phenyl ether (Dowanol PPh), propylene glycol Diacetate (Dowanol PGDA), tripropylene glycol n-butyl ether (Dowanol TPnB), dipropylene glycol n-propyl ether (Dowanol DPnP), ethylene glycol phenyl ether (Dowanol EPh and Dalpad A), 2,2,4-trimethyl-1,3-pentanediol monoisobutyrate (Texanal™ Ester Alcohol), butyl hexyl Cellosolve, butyl hexyl Carbinol Acetate, and tributoxyethyl phosphate.

In certain additional embodiments, the plasticizer is an ester, e.g., an ester alcohol. In certain embodiments, the ester alcohol is a substituted or unsubstituted C1-C20 ester alcohol compound. In certain additional embodiments, the ester alcohol is 2,2,4-trimethyl, 1,3-pentanediol di-isobutyrate (TXIB). In certain additional embodiments, the ester alcohol is 2,2,4-trimethyl-1,3-pentanediol monoisobutyrate (i.e., compound of formula (I)):

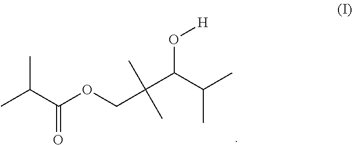

The compound, 2,2,4-trimethyl-1,3-pentanediol monoisobutyrate (C₁₂H₂₄O₃), is available commercially (Eastman Chemical, TN).

In certain additional embodiments, the mastic asphalt composition as described herein comprises a mixture of coalescent agents, e.g., those described herein. For example, in certain embodiments, the coalescent comprises at least one of an ester, an ester alcohol, a substituted or unsubstituted C1-C20 ester alcohol compound, 2,2,4-trimethyl, 1,3-pentanediol di-isobutyrate (TXIB), 2,2,4-trimethyl-1,3-pentanediol monoisobutyrate, analogs or derivatives thereof or a combination thereof.

While all of the coalescents are suitable to function as coalescents, the efficiency of the coalescent in many aqueous systems can be further improved if a coalescent is selected that has low water solubility. Water solubility determines how a coalescing aid is partitioned in the aqueous mastic asphalt composition. In other words, water solubility determines exactly where the coalescing aid is concentrated in the mastic asphalt composition. It is desirable that the coalescent partition more into the polymer/latex phase. A water-insoluble coalescing aid mainly concentrates inside and on the surface of the latex particles. When the polymer particles compact and collapse during drying, the coalescing aid is concentrated at the point of greatest effectiveness-dissolving and softening the polymer. While a water miscible coalescent can be employed, it tends not to be quite as efficient as a poorly water soluble coalescent because a water-soluble material tends to concentrate in the water phase of the mastic asphalt composition. Further, since the mastic asphalt composition will be applied to a porous surface, part of water miscible coalescing aids can migrates into the substrate and would not, therefore, be available for softening the polymer at the onset of coalescence. At some point, a water-soluble coalescing aids must combine with the polymer to be effective. Water-soluble coalescing aids can run the risk that they are carried out of the system by the evaporating water due to azeotrope effects or mass transfer effects.

Accordingly, to further enhance the coalescing efficiency, and coalescent can be selected that is poorly water soluble, that is, one having a solubility of 10 g coalescent/100 g water or less at 25° C. (10% or less), or 8 g/100 g water or less. or 7 g/100 g water or less. or 6 g/100 g water or less. or 5 g/100 g water or less, or 4 g/100 g water or less. or 3 g/100 g water or less. or 2 g/100 g water or less. or 1 g/100 g water or less. or 0.5 g/100 g water or less.

The ratio of polymer to coalescent is not particularly limited, but in certain embodiments the ratio can be in the range of from about 3:1 to about 10:1 by weight, or 4:1 to about 9:1 by weight.

In certain embodiments, the mastic asphalt compositions as described herein are sprayable, i.e., configured for spray coating or spray sealing. The mastic asphalt compositions can be used to spray coat or spray seal any type of surface, for example, parking, driveway, walking, or roofing surfaces.

In any of the aspects or embodiments described herein, the composition can include a polymer. In any of the embodiments described herein, the polymer is a latex polymer or latex co-polymer, e.g., styrene-butadiene-rubber latex, polyisoprene latex, neoprene. The liquid latex portion of the composition may preferably comprise, in one example, a liquid latex-based polymer modifier (such as BASF NS 175, NX 1129, NS 198, or NX 1138 (the BASF Butonal product line); Ultrapave anionic latex products UP-70, UP-7289, or UP-2897; or Ultrapave cationic latex products UP-65K, UP-1152, or UP-1158). The liquid latex portion of the composition can, in one example, preferably comprise from about 0.01% wt to about 20% wt, more preferably from about 0.5% wt to about 10% wt by weight of the total weight of the mastic asphalt composition.

In the composition, the liquid latex additive adheres to both the aggregate material and to the substrate surface (i.e., pavement or roofing surface). The adhesive properties and elasticity of the liquid latex increase the strength, performance and durability of the mastic asphalt composition. Examples of other suitable liquid latex additives include, but are not limited to: various block polymers such as SBS, EVA (ethylene-vinyl acetate), DuPont Evaloy, acrylics, and silicones.

For example, the the polymer can be an acrylate, styrene-acrylic, ethylene-vinyl acetate (EVA), ethylene-acrylate, polyolefins, polybutene-1, amorphous polyolefin, polyamides, polyesters, polyurethanes, polyester-urethane, styrene block copolymers (SBC), polycaprolactone, polycarbonates, fluoropolymers, silicone rubbers, polypyrrole (PPY), styrene-butadiene-styrene (SBS), styrene-ethylene/butylene-styrene (SEBS), styrene-ethylene/propylene (SEP), styrene-isoprene-styrene (SIS), vinyl ethers, conjugated diene compound, vinyl-based aromatic hydrocarbon, hydrogenated conjugated diene-based polymer, non-hydrogenated conjugated diene-based polymer, butyl rubber, natural rubber, ethylene-propylene copolymers or styrene copolymers, singly or in mixture, wherein the copolymers concern statistical, alternating, graft or block copolymers, and combinations thereof.

More specifically, the latex emulsion polymers employed in the mastic asphalt composition can include aqueous vinyl polymers, which are the reaction products of one or more ethylenically unsaturated monomers. Examples of the ethylenically unsaturated monomers include, but are not limited to, styrene, methyl acrylate, methyl methacrylate, ethyl acrylate, ethyl methacrylate, butyl acrylate, butyl methacrylate, isobutyl acrylate, isobutyl methacrylate, ethylhexyl acrylate, 2-ethylhexyl methacrylate, 2-ethylhexyl acrylate, isoprene, octyl acrylate, octyl methacrylate, iso-octyl acrylate, iso-octyl methacrylate, acrylic acid, methacrylic acid, itaconic acid, crotonic acid, a-methyl styrene, vinyl naphthalene, vinyl toluene, chloromethyl styrene, hydroxyethyl (meth)acrylate, hydroxypropyl (meth)acrylate, acrylonitrile, glycidyl methacrylate, acetoacetoxy ethyl methacrylate, acetoacetoxy ethyl acrylate, vinyl chloride, vinylidene chloride, vinyl acetate, butyl acrylamide, ethyl acrylamide, and the like.

The latex polymer can be an addition polymer that may be formed via a free-radical addition polymerization. In such addition polymers, the propagating species may be a free radical, and the polymer is formed in a chain-growth fashion polymerization as understood in the art. If desired, the monomer solution may be emulsified in an aqueous solution, and under agitation reacted via a free-radical polymerization process as described herein, to form latex particles.

Thus, water-based latexes may generally be prepared by polymerizing acrylic (ethylenically unsaturated) monomers. Before conducting polymerization, these ethylenically unsaturated monomers are either pre-emulsified in water/surfactant mixture or used as such. The polymerization process of making these acrylic latexes may also require an initiator (oxidant), a reducing agent, or a catalyst. Suitable initiators include conventional initiators such as ammonium persulfate, sodium persulfate, hydrogen peroxide, t-butyl hydroperoxide, ammonium or alkali sulfate, di-benzoyl peroxide, lauryl peroxide, di-tertiarybutylperoxide, 2,2-azobisisobutyronitrile, benzoyl peroxide, and the like.

Suitable reducing agents are those which increase the rate of polymerization and include, for example, sodium bisulfite, sodium hydrosulfite, sodium formaldehyde sulfoxylate, ascorbic acid, isoascothic acid, and mixtures thereof.

Suitable catalysts are those compounds which promote decomposition of the polymerization initiator under the polymerization reaction conditions thereby increasing the rate of polymerization. Suitable catalysts include transition metal compounds and driers. Examples of such catalysts include, but are not limited to, AQUACATO, ferrous sulfate heptahydrate, ferrous chloride, cupric sulfate, cupric chloride, cobalt acetate, cobaltous sulfate, and mixtures thereof.

A conventional surfactant or a combination of surfactants is used as a stabilizer, such as an anionic or non-ionic emulsifier, in the suspension or emulsion polymerization preparation of a latex emulsion. Examples of preferred surfactants include, but are not limited to, alkali or ammonium alkylsulfate, alkylsulfonic acid, or fatty acid, oxyethylated alkyphenol, sulfosuccinates and derivatives, or any combination of anionic or non-ionic surfactants. A list of suitable surfactants is available in the treatise: McCutcheon's Emulsifiers 84 Detergents, North American Edition, MC Publishing Co., Glen Rock, N.J., 1997. Preferably, the surfactant will provide droplet/particle stability, but result in minimal aqueous phase nucleation (micellar or homogeneous).

The latex emulsion polymers useful according to the invention may have pendant moieties, meaning that the ethylenically unsaturated monomers used to prepare the latex polymers of the invention have been reacted into an addition polymer, and that a portion of the monomers remains as a pendant moiety. Alternatively, we may say that the polymers have residues from the ethylenically unsaturated monomers, in which case we mean that the monomers have been reacted into an addition polymer via their ethylenic unsaturation, and that a portion of the monomers remains as a residue. Both these descriptions are well-known in the art of addition polymers, and the descriptions are not otherwise intended to be especially limiting.

The polymers formed may have a particle size ranging, for example, from about 80 to about 300 nm, or from 100 nm to 250 nm, or from 125 nm to 200 nm.

The amount of latex used in the mastic asphalt composition can be from about 0.01% wt to about 60% wt, or preferably from 0.5-30% wt, or 0.5-20% wt, or 0.5-15% wt, or 0.5-10% wt, or 0.5-8% wt of a polymer based on the total weight of the mastic asphalt composition. Polymers suitable for use in the mastic asphalt compositions as described herein are readily available commercially from a variety sources.

As will be appreciated by those of skill in the art, the polymers listed above are not intended to be limiting on the scope of the invention with the caveat that that the glass transition temperature (Tg) of the polymer should be relatively high. Examples of suitable Tg values for the latex polymer include from 15° C. to 80° C., or from 17° C. to 80° C., or from 20° C. to 80° C., or from 25° C. to 80° C., or from 30° C. to 80° C. or from 35° C. to 80° C. or from 20° C. to 60° C. or from 20° C. to 55° C. or from 25° C. to 55° C. or from 30° C. to 55° C., or from 35° C. to 55° C. The latex polymer should be selected that has a sufficiently high Tg for the mastic asphalt composition to have the desired end use properties.

In certain embodiments, the adhesive formulation includes a copolymer selected from the group consisting of styrene block polymers, styrene, styrene-butadiene copolymers (e.g., SBS, SBR), styrene-isoprene copolymers (SIS), styrene-ethylene/butylene copolymers (SEBS), styrene-ethylene/propylene-styrene copolymers (SEPS) or styrene-isoprene-butylene copolymers (SIBS) and combinations thereof. Such products are known to the person skilled in the art and are commercially available.

In any of the embodiments described herein, the mastic asphalt composition can comprise one or more of water, additional additives or fillers, e.g., copolymer, rheology modifier, filler, particulate or other re-enforcing material, emulsifiers, biocides, pigments, or other materials generally known in the art, and combinations thereof. In any of the aspects or embodiments described herein, these materials may independently be included in amounts ranging from about 0% wt to about 70% wt, including all ranges therebetween based on total weight of the mastic asphalt composition. In certain embodiments, these materials may independently be included in amounts ranging from about 0% wt to about 10% wt based on the total weight of the mastic asphalt composition.

In certain embodiments, the compositions comprise a copolymer, for example, ethylene-vinyl acetate copolymers (EVA). Such copolymers are known to the person skilled in the art. They are polymers with a vinyl acetate content of 10 to 40 mol. % based on the sum of the monomers. They can optionally comprise additional comonomers. These polymers are usually crystalline or partially crystalline. They have a melting point above 70° C. (measured by DSC). The amount of EVA polymer should be 1 to 30% wt. The ratio EVA: styrene block copolymers should be between 1:50 to 3:1, particularly 1:20 to 1:1. If the amount of EVA is increased then it is possible that the cold adhesion will be negatively influenced.

In any of the embodiments of this aspect, the particulate re-enforcing material comprises at least one of clay, calcium carbonate, silica, mineral fines or a combination thereof. As would be appreciated by those of skill in the art, the above are not intended to be limiting on the scope of the invention and any re-enforcing material that is known in the art or that becomes know is intended to be encompassed. In certain embodiments, the clay component can be a non-expansive or an expansive clay. The clay provides a means of suspending the asphalt emulsion and aggregate mixture, as well as other components, in a thixotropic (shear thinning) fluid that prevents rapid separation while still allowing the material to be pumped, sprayed and applied without excessive effort. The clay also plays a role in the dried coating membrane by increasing stiffness and reducing the tendency to track and deform under traffic.

In addition, the mastic asphalt composition described herein preferably has unique rheological properties such that the aggregate material will remain suspended in the sprayable asphalt emulsion from the time that the frictional sealer composition is manufactured, shipped, and spray-applied to the pavement surface until the frictional sealer composition has set. The asphalt composition desirably is thixotropic in nature enabling it to be spray applied under a shear.

In certain embodiments, the emulsifier is selected from the group consisting of anionic, cationic, and non-ionic. Examples of suitable emulsifiers suitable include, but are not limited to: amidoamine emulsifiers; imidazolines; non-ionic emulsifiers; quaternary ammonium emulsifiers; triamines; tetra-amines; penta-amines; amidated tall oil derivatives, e.g., fatty acids or rosins, and others as well as their derivatives.

Ionic emulsifiers which are suitable for use in the present disclosure include amphoteric emulsifiers, cationic emulsifiers, and combinations thereof.

As used herein the term “amphoteric emulsifiers” includes both mono-amphoteric and polyamphoteric emulsifiers. Amphoteric emulsifiers which are suitable for use in the present disclosure include, but are not limited to, the following: C-12 to C-24 (preferably C-16 to C-18) fatty acids, rosin acids, and combinations thereof modified with acrylic acid, maleic anhydride, fumaric acid, and/or other ene- and dieneophiles and further reacted with polyethylene polyamines, lithium C-12 to C-24 alkyl amidopropyl halide methyl carboxylate betaines, sodium C-12 to C-24 alkyl amidopropyl halide methyl carboxylate betaines, potassium C-12 to C-24 alkyl amidopropyl halide methyl carboxylate betaines, lithium C-12 to C-24 alkyl amidopropyl halide phosphate betaines, sodium C-12 to C-24 alkyl amidopropyl halide phosphate betaines, potassium C-12 to C-24 alkyl amidopropyl halide phosphate betaines, lithium C-12 to C-24 alkyl amidopropyl halide sulphate betaines, sodium C-12 to C-24 alkyl amidopropyl halide sulphate betaines, potassium C-12 to C-24 alkyl amidopropyl halide sulphate betaines. Unless the context indicates otherwise, the term “amphoteric emulsifiers” includes the above-noted compounds and their derivatives.

Useful anionic emulsifiers in the compositions described herein include but are not limited to petroleum sulfonates such as alpha-olefin sulfonates or sulfates, soap-type emulsifying agents, typically the alkali metal salts of higher (e.g., C6-C32) fatty acids, such as lauric, myristic, palimitic, oleic, ricinoleic and linoleic acids, or mixtures of acids available from animal or vegetable oils. Other examples of anionic emulsifiers are described in U.S. Pat. No. 4,282,037, the description of which is incorporated herein by reference. Additional anionic surfactants that may be included in the compositions described herein, include, e.g., water-soluble potassium salts of saturated or unsaturated higher (C6-C32) fatty acids, a sodium salt of a sulfuric acid ester of a higher alcohol, a sodium alkyl benzene sulfonate, a sodium salt of a dialkyl succinate sulfonic acid and a sodium salt of an alkyldiphenylether sulfonic acid. Of these, preferred are sodium alkyl benzene sulfonate, sodium lauryl sulfate, a polyoxethylene alkyl (or alkylphenyl)ether sulfonate and the likeA preferred surfactant is an anionic emulsifier such as lignate-surfactant blend (Indulin SA-L, MWV, Charleston Heights, S.C.). Unless the context indicates otherwise, the term “anionic emulsifiers” includes the above-noted compounds and their derivatives.

Cationic emulsifiers which are suitable for use in the compositions described herein include, but are not limited to, the following: fatty imidazolines derived from C-12 to C-24 fatty acids, fatty imidoamines derived from C-12 to C-24 (preferably C-16 to C-18) fatty acids, rosin acids, and combinations thereof modified with maleic anhydride, fumaric acid, and/or other ene- and dieneophiles and further reacted with polyalkylenepolyamines; fatty amidoamines derived from C-12 to C-24 (preferably C-16 to C-18) fatty acids, rosin acids and combinations thereof modified with acrylic acid, maleic anhydride, fumaric acid, and/or other ene- and dieneophiles and further reacted with polyalkylenepolyamines; saturated C-12 to C-24 alkyl monoamines, unsaturated C-12 to C-24 alkyl monoamines, saturated C-12 to C-24 alkyl polypropylenepolyamines; unsaturated C-12 to C-24 alkyl polypropylenepolyamines; saturated C-12 to C-24 alkyl monoamines modified by reaction with ethylene oxide and/or propylene oxide to give polyoxyethylene derivatives; unsaturated C-12 to C-24 alkyl monoamines modified by reaction with ethylene oxide and/or propylene oxide to give polyoxyethylene derivatives; saturated C-12 to C-24 alkyl polypropylenepolyamines modified by reaction with ethylene oxide and/or propylene oxide to give polyoxyethylene derivatives; unsaturated C-12 to C-24 alkyl polypropylenepolyamines modified by reaction with ethylene oxide and/or propylene oxide to give polyoxyethylene derivatives; saturated C-12 to C-24 alkyl aryl monoamines, unsaturated C-12 to C-24 alkyl aryl monoamines; saturated C-12 to C-24 alkyl aryl polypropylenepolyamines, unsaturated C-12 to C-24 alkyl aryl polypropylenepolyamines; C-12 to C-24 quaternary amines; C-12 to C-24 alkyl ether amines; C-12 to C-24 alkylether polyamines; C-12 to C-24 alkyl polypropylene polyamine N-oxides; amine derivatives of tannins, amine derivatives of phenolic resins; amine derivatives of lignins, amine-modified polyacrylates; and combinations thereof. It is preferred that the cationic emulsifier be a member selected from the group consisting of saturated C-12 to C-24 alkyl monoamines, unsaturated C-12 to C-24 alkyl monoamines, saturated C-12 to C-24 alkyl polypropylenepolyamines, unsaturated C-12 to C-24 alkyl polypropylenepolyamines, and combinations thereof. It is further preferred that the cationic emulsifier be a blend of at least one member selected from the group consisting of saturated and unsaturated C-12 to C-24 alkyl monoamines with at least one member selected from the group consisting of saturated and unsaturated C-12 to C-24 alkyl polypropylenepolyamines. Unless the context indicates otherwise, the term “cationic emulsifiers” includes the above-noted compounds and their derivatives.

In certain embodiments, the emulsifiers not only convey the high-temperature shear-stability needed for mixing (and subsequent compacting) of the bituminous compositions, but also impart a high viscosity to the bitumen emulsion (so that no thickener is needed for emulsion stability or for increased film coating on the aggregate) to enhance bitumen wetting of the aggregate surface, and to lower interfacial tension between the bitumen film and aggregate (so that a strong adhesive bond is maintained and water damage to the pavement is prevented).

Emulsifier formulations are further classified as rapid-setting (i.e., spray-grade), quick-setting, and slow-setting depending on the speed with which a given emulsion, using an economical dosage of emulsifier, will break upon contact with mineral aggregate. While rapid-setting, quick-setting, and slow-setting emulsifiers are suitable for use in the present disclosure, it is preferred to employ rapid-setting or quick-setting emulsifiers. It is further preferred to employ rapid-setting emulsifiers with dense-graded aggregate. This preference arises from the need to control such emulsion properties as the interfacial viscosity, Marangoni effect, and interfacial bitumen solubility at the elevated temperature of the present disclosure (i.e., about 50 C to about 120 C) and concurrently at low emulsifier dosages. Quick-setting and slow-setting emulsifiers require higher dosages and do not impart the target interfacial properties in the finished emulsion. Additionally, high emulsifier dosages are costly, contribute to low rates of compressive strength development, and increase moisture sensitivity in the finished pavement.

In certain embodiments, the mastic asphalt compositions comprise at least one of a thickener, starch, salt, metal oxide, alkali agent, or combination thereof.

In a preferred embodiment, the description provides a mastic asphalt composition comprising bitumen or a bitumen emulsion, aggregate, a latex polymer, clay, at least one of an additional polymer or copolymer, a surfactant, an emulsifier, a stabilizer, or a synthetic aggregate, and an ester alcohol.

In certain embodiments, the composition described herein can comprise rheological enhancers and stabilizers may be employed to provide and/or sustain the thixotropic property of the sealer in storage, transport and application and to thereby prevent separation of the components. In certain embodiments, the mastic asphalt composition comprises from about 0% wt to about 10% wt of a rheological enhancer based on the total weight of the mastic asphalt composition.

In certain embodiments, the composition further comprises a biocide or preservative component that prevents or reduces biological growth that may occur within the coating, thus reducing the likelihood of product degradation and odor generation.

In the application method of the present invention, the inventive coating composition can be applied using a conventional wand sprayer, a conventional sealer spray machine, or other conventional equipment.

In another aspect, the disclosure provides a structure, e.g., a pavement or roofing structure, comprising one or more layers of the mastic asphalt as described herein. In certain embodiments, the asphalt compositions as described herein are applied at from about 1 lb/sq. yd to about 20 lb/sq. yd. In certain embodiments, the asphalt compositions as described herein are applied at from about 5 lb/sq. yd. to about 15 lb/sq. yd.

In another aspect, the description provides a method of making an asphalt mastic composition as described herein comprising the steps of: (a) admixing a polymer and an effective amount of a plasticizer to create a first mixture; (b) admixing asphalt or bitumen and at least one of water, aggregate, at least one additive or a combination thereof to create an asphalt or bitumen emulsion; (c) admixing the mixture from (a) with the emulsion from (b).

Where desired, additional additives traditionally employed in the production of bitumen emulsions may be incorporated into the aqueous phase of the bitumen emulsion in order to adjust the characteristics of the finished mix.

In an addition aspect, the disclosure provides methods of producing the mastic asphalt compositions as described herein. In certain embodiments, the method comprises admixing a bitumen emulsion and aggregate, and additionally admixing a latex polymer and a effective amount of an ester alcohol to induce or enhance coalescing of the emulsion in cool, high humidity, or shaded conditions. In certain embodiments, the method comprises a method of producing a sprayable mastic asphalt comprising admixing a bitumen emulsion and aggregate, and additionally admixing a latex polymer and a effective amount of an ester alcohol to induce or enhance coalescing of the emulsion in cool, high humidity, or shaded conditions.

In another aspect, the disclosure provides methods of using the compositions as described herein to coat or seal a surface, e.g., parking, driving, walking or roofing surfaces. In certain embodiments, the method comprises the steps of, providing a mastic asphalt composition as described herein and applying the mastic asphalt at a sufficient amount to coat or seal (partially or completely) a surface, wherein the asphalt mastic dries faster in cool, high humidity or shaded pavement conditions, for example, conditions such as 60 F air temperature, 75% relative humidity, no direct sunlight and pavement temperatures less than 100° F. relative to an asphalt mastic lacking a coalescent and a polymer. In certain embodiments, the method comprises the step of spraying the mastic asphalt compositions as described herein.

The following examples are meant to illustrate, but in no way limit, the claimed invention.

### EXAMPLE 1

Table 1. Exemplary mastic asphalt compositions as described herein are prepared according to the following formulation:

| | Component | Quantity % wt |
|---|---|---|
| 1 | Mineral Fines | 0 to 25% |
| 2 | Aggregate | 0 to 20% |
| 3 | Asphalt Emulsion | 20 to 50% |
| 4 | Polymer Latex | 0.01 to 10% |
| 5 | Carbon Black | 0 to 4% |
| 6 | Hardener | 0 to 10% |
| 7 | Dispersent | 0 to 2% |
| 8 | Viscosity Control | 0 to 10% |
| | Additive | |
| 9 | Coalescent | 0.01 to 5% |
| 10 | Water | 20 to 70% |
| 11 | Biocide | 0 to 1% |

All percent by weight values described herein, including Table 1, are expressed based on the total weight of the “wet” mastic asphalt composition.

### WORKING EXAMPLES

MA: a mastic asphalt composition commercially available from InVia under the name AXYS®, that is further diluted with water to generate a non-volatiles (solids) content of 45% (nv by wt %). EEH: ethylene glycol 2-ethylhexyl ether commercially available from Eastman Chemical Company. DP: diethylene glycol monopropyl ether commercially available from Eastman Chemical Co. DB: diethylene glycol monobutyl ether commercially available from Eastman Chemical Co. Texanol: Eastman Texanol™ ester alcohol

Samples of neat MA were weighed into 50 ml beakers and placed on a magnetic stir bar mixer for 15 min. The neat samples were cast on the MFFT bar using range #3 (41° F. through 73.4° F.). The MFFT bar is a temperature gradient bar that has several temperature range settings in order to determine the temperature at which coalescence occurs. The instrument's surface has coolers on one end and heaters on the other to provide the different temperature ranges. Three different ranges were used to determine the correct MFFT for these samples. Range # 2 has a range from 32° F. to 64.4° F. Range #3 has a range of 41° F. to 73.4° F. and range #4 is from 59° F. to 91.4° F.

The neat MA without coalescent had a MFFT at about 62° F.

After determining the MFFT of the neat MA samples, a set of samples were made by adding the coalescent described in Table 1 below in amounts also set forth in Table 2 on a part per hundred resin based on the solids content of the MA. The MFFT was initially analyzed using the Range #3 bar. The MFFT results can be seen in Table #1.

The dry time of the drawn down films was also recorded and reported in Table 3. The films were continuously observed while drying and the dry time was recorded (on range #4). Range #4 has a lower temperature limit of 59° F., and the time recorded coincided with the time when the film was dry at 59° F. Although MFFT bars are not dry time recorders, the observations are relevant because each machine has a consistent flow of air (4 liters/min) over the samples to assist in drying. After the samples were observed to be dry (color change from jet black to charcoal gray), the MFFT of the samples were measured by the “resist” method. The visual method (the point where the film is no longer has cracks and haze) is typically used to evaluate MFFT results, but these samples could not be evaluated by this method due to their dark color.

The resist method involves scraping the coating off the surface of the machine with a spatula. The temperature at which the coating stops flaking off, starts to roll up and adhere to itself, and becomes more resistant to scraping is determined to be the point of coalescence by this method.

TABLE 2

| | MFFT Range#3 | | |
|---|---|---|---|
| | (Resist Method) | | MFFT |
| PHR | Coalescing Aid | COMMENTS | F. ° |
| 1 | EEH | Machine#6; | 63.4 |
| | | Range #3 | |
| 2 | | | 55.2 |
| 3 | | | 48.3 |
| 4 | | | off scale |
| 5 | | | off scale |
| 1 | Eastman DP | Machine#2; | 66 |
| | | Range #3 | |
| 2 | | | 58.9 |
| 3 | | | 53.7 |
| 4 | | | 50.1 |
| 5 | | | 44.2 |
| 1 | Eastman DB | Machine#3; | 61.5 |
| | | Range #3 | |
| 2 | | | 55 |
| 3 | | | 51.8 |
| 4 | | | 42.3 |
| 5 | | | off scale |
| 1 | Texanol | Machine#1; | 57.8 |
| | | Range #3 | |
| 2 | | | 50.4 |
| 3 | | | off scale |
| 4 | | | off scale |
| 5 | | | off scale |
| 1 | Texanol | Machine#2; | 64.2 |
| | | Range #2 | |
| 2 | | | 58.8 |
| 3 | | | 50.0 |
| 4 | | | 40.8 |
| 5 | | | off scale |

TABLE 3

| | | | Dry time |
|---|---|---|---|
| PHR | Coalescing Aid | COMMENTS | (min) |
| 1 | EEH | Machine#6; | 29 |
| | | Range #4 | |
| 2 | | | 33 |
| 3 | | | 33 |
| 4 | | | 35 |
| 5 | | | 58 |
| 1 | DP | Machine#2; | 53 |
| | | Range #4 | |
| 2 | | | 53 |
| 3 | | | 53 |
| 4 | | | 53 |
| 5 | | | 53 |
| 1 | DB | Machine#3; | 48 |
| | | Range #4 | |
| 2 | | | 53 |
| 3 | | | 53 |
| 4 | | | 53 |
| 5 | | | 53 |
| 1 | Texanol | Machine#1; | 83 |
| | | Range #4 | |
| 2 | | | 74 |
| 3 | | | 74 |
| 4 | | | 78 |
| 5 | | | 83 |

TABLE 4
Evaporation rates are relative to n-butyl acetate which equals 1.

| | Evaporation Rate |
|---|---|
| Product | (nBuOAc = 1) |
| Water | about 0.48 |
| Texanol ™ ester | <0.01 |
| alcohol | |
| Eastman EEH | <0.01 |
| Eastman DB | <0.01 |
| Eastman DP | 0.01 |

Thus, in certain aspects, the description provides a mastic asphalt composition comprising an asphalt or bitumen emulsion, aggregate, a latex polymer, and an effective amount of and a coalescent, wherein the asphalt mastic cures faster in cool, high humidity or shaded pavement conditions.

In any of the embodiments described herein, the MFFT of the mastic asphalt composition is lower than the MFFT of the mastic asphalt composition without said coalescent. In any of the embodiments described herein, the MFFT of the mastic asphalt composition is 60° F. or less. In any of the embodiments described herein, the MFFT of the mastic asphalt composition is 52° F. or less. In any of the embodiments described herein, the MFFT of the mastic asphalt composition is within a range of 42° F. to 55° F.

In any of the embodiments described herein, the mastic asphalt composition dries a rate that is faster than the same mastic asphalt composition without said coalescent. In any of the embodiments described herein, the coalescent has a rate of evaporation that is lower than than of water, based on a rate of evaporation of n-butyl acetate =1. In any of the embodiments described herein, the coalescent has a rate of evaporation that 0.25 or less. In any of the embodiments described herein, the coalescent has a rate of evaporation that 0.1 or less. In any of the embodiments described herein, the coalescent has a rate of evaporation that 0.03 or less. In any of the embodiments described herein, the coalescent has a rate of evaporation that 0.008 or less.

In any of the embodiments described herein, the coalescent has a rate of evaporation that is higher than that of 2,2,4-trimethyl, 1,3-pentanediol di-isobutyrate (TXIB) having a rate of evaporation of 0.0004, based on n-butyl acetate =1.

In any of the embodiments described herein, the coalescent comprises an ester alcohol, a glycol ether, or a glycol ether ester, or mixtures thereof. In any of the embodiments described herein, the coalescent comprises ethylene glycol ethyl ether, ethylene glycol propyl ether, ethylene glycol butyl ether, ethylene glycol 2-ethylhexyl ether, diethylene glycol methyl ether, diethylene glycol ethyl ether, diethylene glycol propyl ether, diethylene glycol butyl ether, propylene glycol methyl ether, ethylene glycol butyl ether acetate, diethylene glycol ethyl ether acetate, propylene glycol methyl ether acetate, propylene glycol n-butyl ether, dipropylene glycol n-butyl ether, tripropylene glycol n-butyl ether, propylene glycol phenyl ether, propylene glycol diacetate, tripropylene glycol n-butyl ether, dipropylene glycol n-propyl ether, ethylene glycol phenyl ether, 2,2,4-trimethyl-1,3-pentanediol monoisobutyrate, butyl hexyl Cellosolve, butyl hexyl Carbinol Acetate, or tributoxyethyl phosphate, or mixtures thereof.

In any of the embodiments described herein, the coalescent comprises an ester alcohol, and said ester alcohol. In any of the embodiments described herein, the coalescent is an ester alcohol. In any of the embodiments described herein, the ester alcohol is a substituted or unsubstituted C1-C20 ester alcohol compound. In any of the embodiments described herein, the ester alcohol comprises 2,2,4-trimethyl-1,3-pentanediol monoisobutyrate is 2-methylpropanoate-2,2,4-trimethyl-1,3-pentanediol (formula (I)), derivative or analog thereof.

In any of the embodiments described herein, the mastic asphalt composition comprises is a glycol ether or a glycol ether ester. In any of the embodiments described herein, the mastic asphalt composition comprises wherein the coalescent comprises ethylene glycol propyl ether, ethylene glycol butyl ether, ethylene glycol 2-ethylhexyl ether, diethylene glycol, diethylene glycol ethyl ether, diethylene glycol propyl ether, diethylene glycol butyl ether, propylene glycol methyl ether, ethylene glycol butyl ether acetate, diethylene glycol ethyl ether acetate, propylene glycol methyl ether acetate, propylene glycol n-butyl ether, dipropylene glycol n-butyl ether, tripropylene glycol n-butyl ether, propylene glycol phenyl ether, propylene glycol diacetate, tripropylene glycol n-butyl ether, dipropylene glycol n-propyl ether, or ethylene glycol phenyl ether, or mixtures thereof.

In any of the embodiments described herein, the coalescent has a water solubility of 10 g coalescent/100 g water or less at 25° C. In any of the embodiments described herein, the coalescent has a water solubility of 6 g/100 g water or less. In any of the embodiments described herein, the coalescent has a water solubility of 2 g/100 g water or less. In any of the embodiments described herein, the composition comprises from 0% wt to about 20% wt of aggregate based on the total weight of the mastic asphalt composition.

In any of the embodiments described herein, the composition comprises from 0.01% wt to about 10% wt of a latex polymer based on the total weight of the mastic asphalt composition.

In any of the embodiments described herein, the composition comprises from about 20% wt to about 50% wt of asphalt or bitumen emulsion based on the total weight of the mastic asphalt composition.

In any of the embodiments described herein, the composition comprises from 0.01% wt to about 5% wt of coalescent based on the total weight of the mastic asphalt composition. The mastic asphalt composition of claim 1, wherein the coalescent is present in an amount within a range of 0.01 phr to 10 phr, based on 100 part of the mastic asphalt composition.

In any of the embodiments described herein, the amount of coalescent is up to 5 phr. In any of the embodiments described herein, the amount of coalescent is up to 4.25 phr. In any of the embodiments described herein, the amount of coalescent is within a range of 0.01-3 phr. In any of the embodiments described herein, the amount of coalescent is within a range of 0.01-2.25. In any of the embodiments described herein, the amount of coalescent is within a range of 0.5-3 phr.

In any of the embodiments described herein, the amount of coalescent is effective to dry the mastic asphalt composition in under 120 minutes, as measured under the conditions of cast the mastic asphalt composition using a 6 ml gap draw down bar, heated to 59° F., under a flow of air at 4 liter/min and at a pressure of 60 psi. In any of the embodiments described herein, the dry time is 90 minutes or less. In any of the embodiments described herein, the dry time is 60 minutes or less.

In any of the embodiments described herein, the type and amount of coalescent is effective to shorten the dry time of a same mastic asphalt composition without coalescent by at least 20%. In any of the embodiments described herein, the dry time is shortened by at least 35%.

In any of the embodiments described herein, the mastic asphalt composition further comprises at least one of a particulate re-enforcing material, an additive or a combination of thereof.

In any of the embodiments described herein, the mastic asphalt composition is sprayable.

In any of the embodiments described herein, the additive comprises at least one of a surfactant, emulsifier, rheology modifier, stabilizer, a filler, polymer, co-polymer or combination thereof. In any of the embodiments described herein, the emulsifier is selected from the group consisting of anionic, cationic, and non-ionic.

In any of the embodiments described herein, the filler is a particulate re-enforcing material. In any of the embodiments described herein, the particulate re-enforcing material is at least one of clay, calcium carbonate, silica, mineral fines or a combination thereof.

In an additional aspect, the description provides a structure comprising a coating or layer of the mastic asphalt composition as described herein.

In another aspect, the description provides a method of coating a substrate or structure comprising the steps of providing a mastic asphalt composition as described herein, and a substrate, and applying a coating of the mastic asphalt composition. In any of the embodiments described herein, the mastic asphalt composition is applied by spraying.

In another aspect, the description provides a method of making an asphalt mastic composition comprising the steps of: (a) admixing a polymer and an effective amount of a coalescent to create a first mixture; (b) admixing asphalt or bitumen and at least one of water, aggregate, at least one additive or a combination thereof to create an asphalt or bitumen emulsion; (c) admixing the mixture from (a) with the emulsion from (b) to form the asphalt mastic composition. In any of the embodiments described herein, the mastic asphalt composition is applied to a substrate by spraying.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A mastic asphalt composition comprising an asphalt or bitumen emulsion, aggregate, a latex polymer, and a coalescent.

2. The mastic asphalt composition of claim 1, wherein the MFFT of the mastic asphalt composition is lower than the MFFT of the mastic asphalt composition without said coalescent.

3. The mastic asphalt composition of claim 1, wherein the MFFT of the mastic asphalt composition is 60 F or less.

4. The mastic asphalt composition of claim 1, wherein the MFFT of the mastic asphalt composition is 52 F or less.

5. The mastic asphalt composition of claim 1, wherein the MFFT of the mastic asphalt composition is within a range of 42 to 55.

6. The mastic asphalt composition of claim 1, wherein the mastic asphalt composition dries a rate that is faster than the same mastic asphalt composition without said coalescent.

7. The mastic asphalt composition of claim 1, wherein the coalescent has a rate of evaporation that is lower than than of water, based on a rate of evaporation of n-butyl acetate =1.

8. The mastic asphalt composition of claim 7, wherein the coalescent has a rate of evaporation that 0.25 or less.

9. The mastic asphalt composition of claim 7, wherein the coalescent has a rate of evaporation that 0.1 or less.

10. The mastic asphalt composition of claim 7, wherein the coalescent has a rate of evaporation that 0.03 or less.

11. The mastic asphalt composition of claim 7, wherein the coalescent has a rate of evaporation that 0.008 or less.

12. The mastic asphalt composition of claim 1, wherein the coalescent has a rate of evaporation that is higher than that of 2,2,4-trimethyl, 1,3-pentanediol di-isobutyrate (TXIB) having a rate of evaporation of 0.0004, based on n-butyl acetate =1.

13. The mastic asphalt composition of claim 1, wherein the coalescent comprises at least one of an ester, ester alcohol, a glycol ether, or a glycol ether ester, or mixtures thereof.

14. The mastic asphalt composition of claim 13, wherein the coalescent comprises ethylene glycol ethyl ether, ethylene glycol propyl ether, ethylene glycol butyl ether, ethylene glycol 2-ethylhexyl ether, diethylene glycol methyl ether, diethylene glycol ethyl ether, diethylene glycol propyl ether, diethylene glycol butyl ether, propylene glycol methyl ether, ethylene glycol butyl ether acetate, diethylene glycol ethyl ether acetate, propylene glycol methyl ether acetate, propylene glycol n-butyl ether, dipropylene glycol n-butyl ether, tripropylene glycol n-butyl ether, propylene glycol phenyl ether, propylene glycol diacetate, tripropylene glycol n-butyl ether, dipropylene glycol n-propyl ether, ethylene glycol phenyl ether, 2,2,4-trimethyl-1,3-pentanediol monoisobutyrate, butyl hexyl Cellosolve, butyl hexyl Carbinol Acetate, or tributoxyethyl phosphate, or mixtures thereof.

15. The mastic asphalt composition of claim 13, wherein the coalescent comprises at least one of an ester, an ester alcohol, a substituted or unsubstituted C1-C20 ester alcohol compound, 2,2,4-trimethyl,1,3-pentanediol di-isobutyrate (TXIB), 2,2,4-trimethyl-1,3-pentanediol monoisobutyrate derivatives or analogs thereof and combinations thereof.

16. The mastic asphalt composition of claim 15, wherein the ester alcohol comprises at least one of 2,2,4-trimethyl,1,3-pentanediol di-isobutyrate (TXIB), 2,2,4-trimethyl-1,3-pentanediol monoisobutyrate (formula (I)): 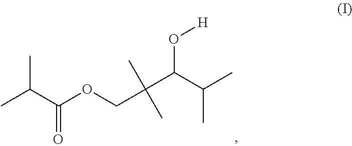
analogs or derivatives thereof or combinations thereof.

17. The mastic asphalt composition of claim 13, wherein the mastic asphalt composition comprises is a glycol ether or a glycol ether ester.

18. The mastic asphalt composition of claim 17, wherein the mastic asphalt composition comprises wherein the coalescent comprises ethylene glycol propyl ether, ethylene glycol butyl ether, ethylene glycol 2-ethylhexyl ether, diethylene glycol, diethylene glycol ethyl ether, diethylene glycol propyl ether, diethylene glycol butyl ether, propylene glycol methyl ether, ethylene glycol butyl ether acetate, diethylene glycol ethyl ether acetate, propylene glycol methyl ether acetate, propylene glycol n-butyl ether, dipropylene glycol n-butyl ether, tripropylene glycol n-butyl ether, propylene glycol phenyl ether, propylene glycol diacetate, tripropylene glycol n-butyl ether, dipropylene glycol n-propyl ether, or ethylene glycol phenyl ether, or mixtures thereof.

19. The mastic asphalt composition of claim 1, wherein the coalescent has a water solubility of 10 g coalescent/100 g water or less at 25° C.

20. The mastic asphalt composition of claim 19, wherein the coalescent has a water solubility of 6 g/100 g water or less.

21. The mastic asphalt composition of claim 20, wherein the coalescent has a water solubility of 2 g/100 g water or less.

22. The mastic asphalt of claim 1, wherein the composition comprises from 0% wt to about 20% wt of aggregate based on the total weight of the mastic asphalt composition.

23. The mastic asphalt of claim 1, wherein the composition comprises from 0.01% wt to about 10% wt of a latex polymer based on the total weight of the mastic asphalt composition. The mastic asphalt of claim 1, wherein the composition comprises from about 20% wt to about 50% wt of asphalt or bitumen emulsion based on the total weight of the mastic asphalt composition.

24. The mastic asphalt composition of claim 1, wherein the coalescent is present in an amount within a range of 0.01 phr to 10 phr, based on 100 part of the mastic asphalt composition.

25. The mastic asphalt composition of claim 24, wherein the amount of coalescent up to 5 phr.

26. The mastic asphalt composition of claim 24, wherein the amount of coalescent is up to 4.25 phr.

27. The mastic asphalt composition of claim 24, wherein the amount of coalescent is within a range of 0.01-3 phr.

28. The mastic asphalt composition of claim 24, wherein the amount of coalescent is within a range of 0.01-2.25.

29. The mastic asphalt composition of claim 24, wherein the amount of coalescent is within a range of 0.5-3 phr.

30. The mastic asphalt composition of claim 1, wherein the amount of coalescent is effective to dry the mastic asphalt composition in under 120 minutes, as measured under the conditions of cast the mastic asphalt composition using a 6 mil gap draw down bar, heated to 59° F., under a flow of air at 4 liter/min and at a pressure of 60 psi.

31. The mastic asphalt composition of claim 30, wherein the dry time is 90 minutes or less.

32. The mastic asphalt composition of claim 30, wherein the dry time is 60 minutes or less.

33. The mastic asphalt composition of claim 1, wherein the type and amount of coalescent is effective to shorten the dry time of a same mastic asphalt composition without coalescent by at least 20%.

34. The mastic asphalt composition of claim 33, wherein the dry time is shortened by at least 35%.

35. The mastic asphalt composition of claim 1, further comprises at least one of a particulate re-enforcing material, an additive or a combination of thereof.

36. The mastic asphalt composition of claim 1, wherein the composition is sprayable.

37. The mastic asphalt composition of claim 1, wherein the additive comprises at least one of a surfactant, emulsifier, rheology modifier, stabilizer, a filler, polymer, co-polymer or combination thereof. The mastic asphalt composition of claim 12, wherein the emulsifier is selected from the group consisting of anionic, cationic, and non-ionic.

38. The mastic asphalt composition of claim 10, wherein the particulate re-enforcing material is at least one of clay, calcium carbonate, silica, mineral fines or a combination thereof.

39. A structure comprising a coating or layer of the mastic asphalt composition of claim 1.

40. A method of coating a substrate or structure comprising the steps of providing a mastic asphalt composition of claim 1 and a substrate, and applying a coating of the mastic asphalt composition.

41. The method of claim 16, wherein the mastic asphalt composition is applied by spraying.

42. A method of making an asphalt mastic composition comprising the steps of:
(a) admixing a polymer and a coalescent to create a first mixture;
(b) admixing asphalt or bitumen and at least one of water, aggregate, at least one additive or a combination thereof to create an asphalt or bitumen emulsion;
(c) admixing the mixture from (a) with the emulsion from (b) to form the asphalt mastic composition.

43. The method of claim 43, wherein the mastic asphalt composition is applied to a substrate by spraying.
